(19) United States
(12) Patent Application Publication
(10) Pub. No.: US 2024/0319368 A1
(43) Pub. Date: Sep. 26, 2024

(54) SYSTEMS AND METHODS FOR DEVICE POSITIONING

(71) Applicant: Apple Inc., Cupertino, CA (US)

(72) Inventor: Libo Cao Meyers, San Jose, CA (US)

(21) Appl. No.: 18/611,283

(22) Filed: Mar. 20, 2024

Related U.S. Application Data
(60) Provisional application No. 63/453,237, filed on Mar. 20, 2023.

(51) Int. Cl. G01S 17/86

(52) U.S. Cl. CPC G01S 17/86

(57) ABSTRACT

Implementations described herein provide systems and methods for controlling device positioning. In one implementation, a structure of an environment external to a target device is identified. A spatial relationship between the structure and a position of the target device within the environment is determined, and a representation of the spatial relationship between the structure and the position of the target device is generated.

### CROSS-REFERENCE TO RELATED APPLICATIONS

The present application claims priority to U.S. Provisional Application Ser. No. 63/453,237, filed Mar. 20, 2023, which is incorporated by reference herein in its entirety.

### FIELD

Aspects of the present disclosure relate to systems and methods for device positioning and more particularly to precisely determining and controlling a position of a target device within an environment.

### BACKGROUND

Devices, such as mobile devices, may be disposed in various positions during storage. Understanding and controlling a position of a device, particularly from a remote location, may be challenging.

### SUMMARY

Implementations described and claimed herein provide systems and methods for device positioning. In some implementations, a structure of an environment external to a target device is identified. The target device is disposed in a position within the environment. A spatial relationship between the structure and the position of the target device within the environment is determined. The spatial relationship includes an orientation of the target device relative to the structure. A representation of the spatial relationship between the structure and the position of the target device is generated, with the representation of the spatial relationship being output for presentation using a user device.

In some implementations, sensor data, is obtained, with the sensor data being captured using at least one sensor of a target device. A structure of an environment external to the target device is identified using the sensor data. The target device is disposed in a position within the environment. A spatial relationship between the structure and the position of the target device within the environment is determined. The spatial relationship includes an orientation of the target device relative to the structure. A representation of the spatial relationship between the structure and the position of the target device is generated, with the representation being output for display using a display associated with the target device.

In some implementations, a controller renders a representation of a spatial relationship between a structure of an environment external to a target device and a position of the target device within the environment. The spatial relationship includes an orientation of the target device relative to the structure. A display displays the spatial relationship between the structure of the environment external to the target device and the position of the target device within the environment.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 shows an example a target device within an environment.

FIG. 2 shows an example target device in communication with a user device.

FIG. 3 illustrates an example structure frame of reference relative to an example target device frame of reference.

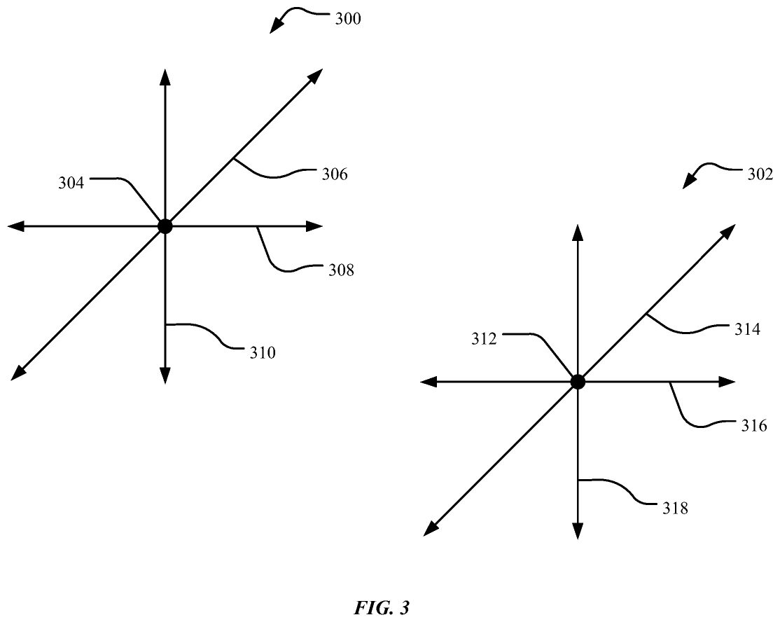

FIG. 4 shows an example component frame of reference relative to an example target device frame of reference.

FIG. 5 shows an example target device.

FIG. 6 illustrates example operations for device positioning.

FIG. 7 illustrates example operations for device positioning.

FIG. 8 shows an example computing system for device positioning.

### DETAILED DESCRIPTION

Aspects of the presently disclosed technology relate to determining a position of a target device within an environment and controlling the position using a representation of the environment. In one aspect, a structure is disposed within the environment external to the target device. The structure is identified, for example using sensor data captured by at least one sensor of the target device. A spatial relationship between the structure and the position of the target device is determined. The spatial relationship includes an orientation, such as a tilt, heading, proximity, etc., of the target device relative to the structure. A representation of the spatial relationship between the structure and the position of the target device may be generated and output for presentation using a user device, which may be part of or remote from the target device. The representation may be generated in response to a query from the user device for the position of the target device and used to control the position of the target device.

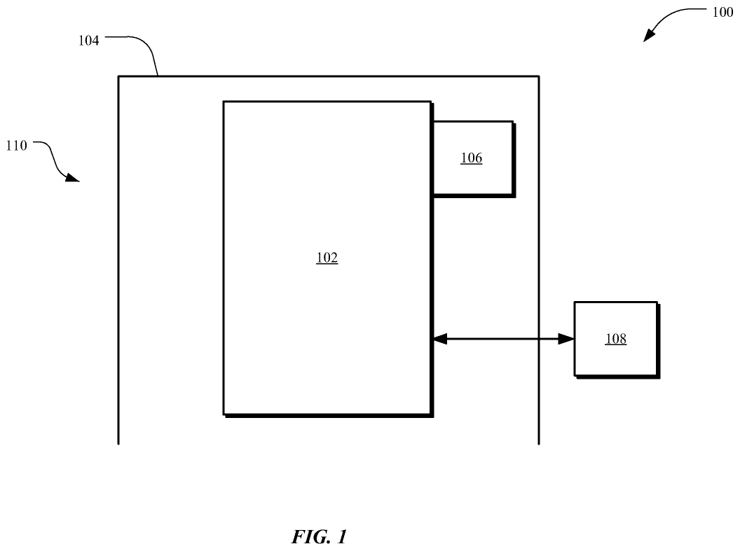

To begin a detailed description of device positioning within an environment 100, reference is made to FIG. 1. A target device 102 is positioned within the environment 100. The target device 102 may be mobile or stationary. The target device 102 may further include one or more moveable components and/or one or more fixed components. The target device 102 may be configured to move in a variety of manners within various degrees of freedom (e.g., one, two, three, four, five, six, etc. degrees of freedom). In some examples, the target device 102 may be mounted on an object, such as a moveable platform, system, and/or surface, with the target device 102 itself being stationary or at least partially moveable. In other examples, the target device 102 may be mounted to or resting on a fixed surface and include one or more moveable components. In other examples, the target device 102 is configured to move along a movement path and may include one or more moveable components configured to move relative to a frame of reference of the target device 102.

In some implementations, the target device 102 may receive a storage command and move to the position within the environment 100 in response. In other implementations, the target device 102 may be disposed at the position within the environment 100 as a fixed position or be disposed at the position, temporarily or otherwise, in connection with another movement and/or operation. The environment 100 may include one or more structures 104, including without limitation, objects, surfaces, lines, and/or boundaries. In one example, the structure 104 defines a storage space, and the target device 102 is positioned in the environment 100 within the storage space. In another example, the structure 104 is disposed within an operational space in which the target device 102 operates. The target device 102 may include one or more moveable components 106. Each of the moveable components 106 may be mounted or otherwise connected to or part of the target device 102. The moveable components 106 may be configured to move relative to at least a portion of the target device 102 in various manners. In some examples, the target device 102 is positioned on the moveable component 106 to move the target device 102 within the environment 100.

The target device 102 may be in communication with a user device 108, which may be part of and/or separate from the target device 102. For example, the user device 108 may be disposed within an interior of the target device 102. The user device 108 may be fixed within the interior or removable from the interior. The user device 108 may be in communication with the target device 102 from a remote location, for example over a network and using an Application Programming Interface (API). The position of the target device 102 may be understood and controlled using the user device 108.

More particularly, in some implementations, the user device 108 generates a query for the position of the target device 102, for example, in response to user input. The user device 108 sends the query to the target device 102 (e.g., using the API). In response to the query or otherwise in connection with moving the target device 102 into the position, a current position of the target device 102 is determined with precision. For example, the position may include latitude, longitude, altitude, heading, levelness, alignment, and/or other orientation parameters of the target device 102. The position may similarly include a current and/or projected orientation of one or more of the moveable components 106 of the target device 102.

A representation of the position of the target device 102 is generated and rendered for presentation using the user device 108. The representation may include various details of the orientation of the target device 102, including angles, outlines, shapes (e.g., outer shape, surface shapes, etc.), relationships, and/or the like. The representation includes one or more two-dimensional views (e.g., a top plan view) or a three-dimensional view of the target device 102 within the environment 100. The representation may further include various details of the orientation of the movable component(s) 106, similarly including angles, outlines, shapes (e.g., outer shape, surface shapes, etc.), relationships, and/or the like. In some implementations, the representation of the position of the target device 102 includes a spatial relationship 110 between the position of the target device 102 and the structure(s) 104, with the spatial relationship 110 including an orientation of the target device 102 relative to the structure(s) 104. The spatial relationship 110 may further include a component relationship between the structure(s) 104 and the movable component(s) 106. The component relationship may include an orientation of the moveable component(s) 106 relative to the target device 102 and/or the structure(s) 104.

The representation of the spatial relationship 110 may be presented using the user device 108. In some implementations, the spatial relationship 110 is presented through an interactive interface, permitting a user to interact with one or more aspects of the spatial representation 110. For example, the user device 108 may capture a movement command specifying an action for movement by the target device 102, the moveable component(s) 106, the structure 104, and/or other objects associated with the target device 102 and/or within the environment 100. The action may include moving the moveable component 106 from a first orientation to a second orientation, adjusting the position of the target device 102 and/or the moveable component 106, and/or the like. The target device 102 or other object may generate a motion plan to move based on the movement command, one or more objects present in the environment 100 (e.g., the structure 104, etc.), sensor data, and/or information about the target device 102 and/or the environment. In some implementations, the movement command includes an indicated position and/or trajectory. The target device 102 may adapt the indicated position and/or trajectory of the movement command for movement of the target device 102 in the environment 100. For example, the indicated position and/or trajectory may be adapted by the target device 102 in accordance with operational parameters of the target device 102, in view of one or more objects in the environment 100, and/or other movement considerations. In some implementations, the user device 108 prevents a movement command that would conflict with movement considerations (e.g., operational parameters of the target device 102 and/or the environment 100), where generating the motion plan includes prompting the user to modify the movement command in view of the movement considerations. The representation of the spatial relationship 110 may update with any adjustments of the position of the target device 102 accordingly. In this manner, the user device 108 may obtain the position of the target device 102 with precision and control the position, including from a remote location.

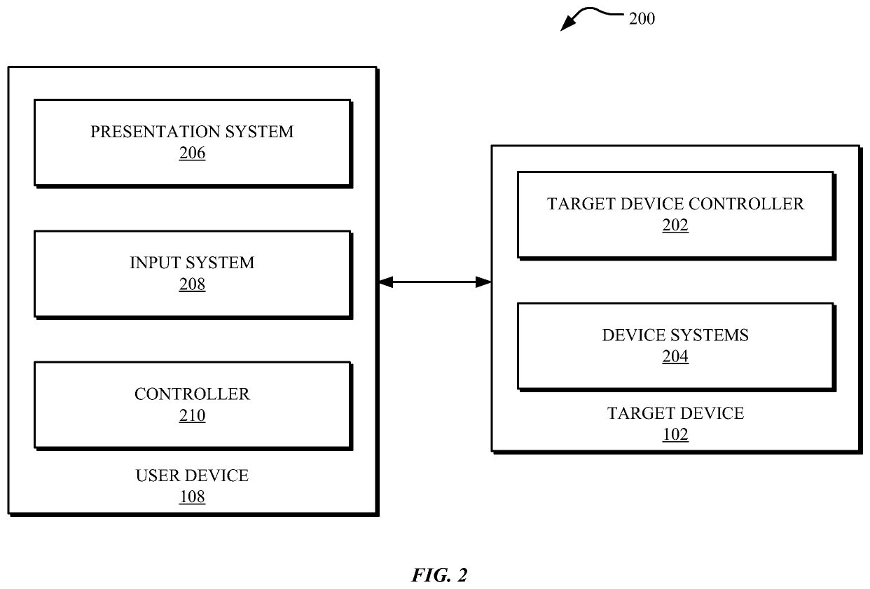

Turning to FIG. 2, an example system 200 includes the user the target device 102 in communication with the user device 108 in various manners for presenting the precise position of the target device 102. In some implementations, the user device 108 includes a presentation system 206, an input system 208, and a controller 210. The user device 108 may be a workstation, smartphone, tablet, wearable, dashboard, and/or the like. The user device 108 may be used to control movement of and otherwise communicate with the target device 102.

In some implementations, the target device 102 includes a target device controller 202 and one or more device systems 204. The target device controller 202 controls operation of the target device 102, including controlling the various device systems 204, which may include a perception system (e.g., for capturing perception data corresponding to the environment 100 external to and in which the target device 102 is located), a navigation system, a power system, actuators, controls, and/or other devices and systems of the target device 102. In one implementation, the user device 108 is separate from the target device 102. In another implementation, the user device 108 is part of the target device 102, with the presentation system 206, the input system 208, and the controller 210 integrated into the target device 102 for controlling movement of the target device 102. The controller 210 and the target device controller 202 may be separate or integrated systems. Each of the user device 108 and the target device 102 may optionally include one or more of the presentation system 206, the input system 208, and the controller 210 for controlling movement of the target device 102.

The input system 208 may include one or more input devices configured to capture various forms of user input. For example, the input system 208 may be configured to capture visual input (e.g., information provided via gesture), audio input (e.g., information provided via voice), tactile input (e.g., information provided via touch, such as via a touch-sensitive display screen (“touchscreen”), etc.), device input (e.g., information provided via one or more input devices), and/or the like from a user. Similarly, the presentation system 206 may include one or more output devices configured to present output data in various forms, including visual (e.g., via display, projection, etc.), audio, and/or tactile. The input system 208 and/or the presentation system 206 may include various software and/or hardware for input and presentation. The input system 208 and the presentation system 206 may be integrated into one system, in whole or part, or separate. For example, the input system 208 and the presentation system 206 may be provided in the form of a touchscreen.

In some implementations, the presentation system 206 and the input system 208 provide an interactive interface. The interactive interface may be provided via an instrument panel, an interactive dashboard, a touchscreen, a heads-up-display, a headset, a wearable, and/or the like. The interactive interface may be deployed in the target device 102. For example, the interactive interface may be deployed in an interior of the target device 102, thereby facilitating interactions with one or more occupants that may be transported in the target device 102. In another implementation, the interactive interface is deployed separately from the target device 102 to facilitate interactions with one or more users while being disposed within, separate from, and/or outside of the target device 102. In one example, the target device 102 may determine whether the user device 108 is within a threshold distance and if so, permit one or more users to interact with the interactive interface to determine and control the position of the target device 102 using the user device 108.

The representation of the spatial relationship 110 may be generated and presented as an interactive interface using the presentation system 206. The representation of the spatial relationship 110 may be simplified representations of the target device 102 and the structure 104. For example, the representation of the target device 102 may be a first graphical object (e.g., icon), which is presented relative to one or more second graphical objects (e.g., icons) representing the structures 104. The first graphical object may further include a portion corresponding to the moveable component(s) 106. Additionally or alternatively, the representations of the target device 102, the moveable component(s) 106, and the structure 104 may include photorealistic features and/or images. The representation may include various augmented features, virtual reality features, and/or the like.

In some implementations, the representation of the spatial relationship 110 is presented as an interactive interface for interaction with a user. In accordance with the interaction of the user, a movement command specifying an action for movement by the target device 102 is obtained via the input system 208. For example, the movement command may be specified through a manipulation of the representation of the target device 102. The manipulation may include: moving, dragging, swiping, flicking, pulling, pushing, rotating, tapping, and/or the like. The manipulation may be within a two-dimensional (2D) plane or within three-dimensional (3D) space. Further, the manipulation may include moving the representation of the target device 102 and/or the representation(s) of the moveable component(s) 106 relative to the representation of the structure(s) 104.

The action of the movement command may specify a target destination, a target movement, and/or a target operation of the target device 102 and/or the moveable component(s) 106 based on one or more indicated destinations, indicated movements, and/or indicated operations obtained through the manipulation of the representation of the target device 102. The target device controller 202 and/or the controller 210 generates a motion plan for the target device 102 and/or a related component of the target device 102 (e.g., the moveable component(s) 106, the structure(s) 104, etc.) reflecting the movement command. The motion plan specifies the action for movement by the target device 102 and/or relevant object. For example, the movement command may include an indicated destination (e.g., an indicated position, indicated orientation, etc.), such that the action of the motion plan is adapted for moving the target device towards a destination reflecting the indicated destination or moving the target device 102 and/or the moveable component(s) 106 into the indicated orientation. The target device controller 202 may generate a target and a trajectory for movement in the environment 100 based on the motion plan. The target device controller 202 controls the device systems 204 of the target device 102 in accordance with the motion plan to move the target device 102 along the trajectory based on the target. It will be appreciated that the target may include: a target destination (e.g., target position, target orientation, etc.) that the target device 102 and/or the moveable component(s) 106 moves along the trajectory towards. The action may include various operation(s) associated with moving the target device 102 and/or the moveable component(s) 106 in accordance with executing the motion plan. The target device controller 202 may autonomously control the target device 102 and/or the moveable component(s) 106, including one or more of the device systems 204, based on the motion plan.

In one example, the movement command includes a storage command for moving the target device 102 into the position within a storage space that may be defined based on the structure 104. The storage command may include instructions for parking the target device 102 in a particular orientation within the storage space. In doing so, the target device 102 is not only instructed on where to park but also how to park. The storage command may be generated automatically (e.g., based on scan data in connection with arriving at a destination) and/or based on user input. The structure 104 (e.g., parking lines) may be identified using the scan data. The spatial relationship 110 between the position of the target device 102 and the structure 104 within the environment 100 is determined, with the spatial relationship 110 including the orientation of the target device 102 relative to the structure 104. For example, the orientation may include an heading of the target device 102 relative to the parking lines, a tilt of the target device 102 relative to a surface of the storage space, a distance of portions of the target device 102 from the parking lines, and/or an overall alignment of the target device 102 within the storage space. The spatial representation 110 may further include the component representation between the moveable component 106 (e.g., a tire, door, etc.) and structure 104 and/or the target device 102. The component representation includes a component orientation of the moveable component 106 relative to the target device 102. For example, the component orientation may include an angle of the moveable component 106 relative to the target device 102 (e.g., tire angle relative to a body of the target device 102, etc.), a projected orientation of the moveable component 106 relative to the target device 102 (e.g., a door path, etc.). The spatial representation 110 may be rendered for display and interaction with the user device 108, such that the position of the target device 102, including orientation of the target device 102 and/or the moveable components 106, may be viewed and controlled with precision.

In some implementations, the position of the target device 102, including orientation of the target device 102 and/or the moveable components 106 is determined using one or more sensors of the target device 102. Such sensors may determine, without limitation, latitude, longitude, altitude, heading, levelness, alignment, engagement (e.g., open, closed, etc.), and/or other orientation parameters of the target device 102, including the moveable components 106. In some implementations, the position of the target device 102 is determined in a context of the environment 100, for example with respect to the structure(s) 104.

For example, the structure 104 within the environment 100 may be selected for determining precise positioning of the target device 102. The structure 104 may be selected based on structure type, configuration of the structure 104, and/or based on other predefined criteria. The structure type may correspond to types of structures relevant to an action of the target device 102. In one example, the target device 102 may be disposed in the position within the environment 100 in connection with execution of a storage command to park. The structure type may correspond to the storage command, such that the selected structure 104 is relevant to parking (e.g., parking lines, parking barrier, garage space, etc.). In some examples, the structure 104 is selected based on the configuration of the structure 104 (e.g., having surfaces, corners, shapes, etc. that facilitate alignment). Identifying the structure 104 may further include defining a structure frame of reference 300 for the structure 104 to compare with a target device frame of reference 302 for the target device 102.

In some implementations, the structure frame of reference 300 is defined based on a structure origin point 304. The structure origin point 304 may be set at any location corresponding to the structure 104. For example, where the structure 104 includes a storage space, the structure origin point 304 may be set at a center of the storage space, along a line defining the storage space, at an intersection of a plurality of lines defining the storage space, on a surface of the storage space, above or adjacent to the surface of the storage space, etc. The structure frame of reference 300 may include one or more structure axes (e.g., a first structure axis 306, a second structure axis 308, and/or a third structure axis 310) extending from the structure origin point 304. The structure axes may be orthogonal to each other. The structure axes may align with features of the structure 104. For example, the first structure axis 306 may extend along a longitudinally extending parking line associated with a storage space (e.g., parking space) and the second structure axis 308 may extend laterally along an end of the storage space. In some examples, the first structure axis 306 and the second structure axis 308 correspond to a structure surface defining the storage space. In these examples, the third structure axis 310 extends in an upward direction from the storage surface. Variations in height in the storage surface may be determined using the third structure axis 310, or in some examples, such height variations are approximated to a storage plane extending in longitudinal and lateral directions defined by the first and second structure axes 306-308, such that the third structure axis 310 is discarded.

The target device frame of reference 302 may be defined based on a target device origin point 312, which may be set at any location corresponding to the target device 102. For example, the target device origin point 312 may be set at a geometric center of the target device 102, a center of gravity of the target device 102, a center of a laterally extending edge (e.g., a front or a rear), a center of a longitudinally extending edge (e.g. a side), etc. The target device frame of reference 302 may include one or more target device axes (e.g., a first target device axis 314, a second target device axis 316, and/or a third target device axis 318) extending from the target device origin point 312. The target device axes may be orthogonal to each other. In some examples, the first target device axis 314 extends along a longitudinal direction (e.g., a length of the target device 102, the second target device axis 316 extends along a lateral direction (e.g., a width of the target device 102), and the third target device axis 318 extends along a vertical direction (e.g., a height of the target device 102). The first target device axis 314 may correspond to directions of motion that the target device 102 is configured to move along (e.g., in forward or reverse directions). Stated differently, the target device 102 is configured to move along a movement path in directions corresponding to the first target device axis 314. The target device 102 may include a steering system configured to turn the target device 102 and change this direction of movement using one or more of the moveable components 106.

The structure frame of reference 300 may be compared with the target device frame of reference 302 to determine the spatial relationship 110 between the position of the target device 102 and the structure 104 within the environment 100. In some implementations, the structure frame of reference 300 is fixed relative to the structure 104, and the target device frame of reference 302 is fixed relative to the target device 102. The structure frame of reference 300 and thus the structure 104 may be taken as stationary in determining the spatial relationship 110. In this example, the target device 102 and thus the target device frame of reference 302 are configured to move relative to the structure frame of reference 300 and the structure 104. However, it will be appreciated that either frame of reference may be set as fixed or movable relative to the other in determining the spatial relationship 110.

In some examples, one or more of the structure axes may be compared with one or more of the target device axes to determine the orientation of the target device 102 relative to the structure 104. The orientation may include, without limitation, a heading of the target device 102 relative to the structure 104, a tilt of the target device 106 relative to the structure 104, a proximity of the target device 102 relative to the structure 104, and/or other orientation parameters. The heading may be determined based on an angle between at least one of the target device axes and at least one of the structure axes. For example, the heading may be determined based on an angle of the first target device axis 314 relative to the first structure axis 306 along the structure plane. The heading may indicate that the target device 102 is parked at an angle within the storage space, such that the target device 102 is not aligned with the parking lines. The tilt may be determined based on an angle between at least one of the target device axes and at least one of the structure axes. A tilt may be a lateral tilt or a longitudinal tilt. The lateral tilt may be determined based on an angle of the second target device axis 316 relative to the second structure axis 308 in a vertical direction, and the longitudinal tilt may be determined based on an angle of the first target device axis 314 relative to the first structure axis 306 in the vertical direction. The tilt of the target device 102 may indicate if the target device 102 is parked on an uneven surface in the storage space. The proximity of the target device 102 relative to the structure 104 may be determined based on a separation of the target device origin point 312 relative to the structure origin point 304. The proximity may further be determined based on a known distance between the target device origin point 312 and one or more points on the target device 102 (e.g., points along outer edges of the target device 102, etc.) and/or a known distance between the structure origin point 304 and points on the structure 104 (e.g., points along surfaces of the structure 104, lines of the structure 104, etc.). The proximity of the target device 102 relative to the structure 104 may be used to determine if the target device 102 is parked too closely with the edge of the storage space (e.g., parking line, another target device, a wall, etc.). In some examples, the spatial relationship 110 is determined based on a yaw, pitch, and/or roll of the target device frame of reference 302 relative to the structure frame of reference 300, with the yaw indicating a displacement around the third structure axis 310 by the target device frame of reference 302, the pitch indicating a displacement around the second structure axis 308 by the target device frame of reference 302, and the roll indicating a displacement around the first structure axis 306 by the target device frame of reference 302.

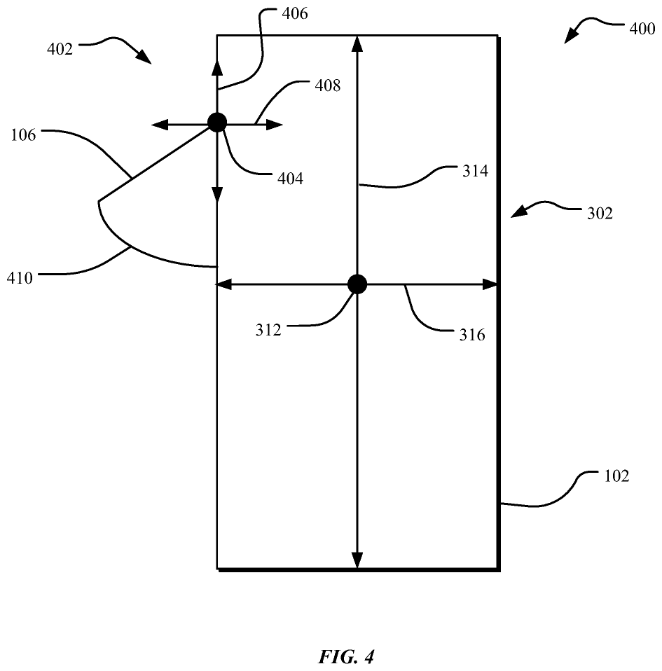

As can be understood from FIG. 4, in some implementations, the spatial relationship 110 includes a component relationship 400 between the moveable component 106 and the structure 104 and/or other portions of the target device 102 (e.g., a body of the target device 102). In one example, the moveable component 106 is connected to and configured to move relative to the target device 102. The moveable component 106 may be configured to move along one or more directions relative to and/or in conjunction with the target device 102. The component relationship 400 may include a component orientation of the moveable component 106 relative to the structure 106 and/or the target device 102. The component orientation may include a heading, tilt, proximity, and/or other orientation parameters of the moveable component 106. For example, the moveable component 106 may be a wheel with the component orientation including an angle of the tire relative to the body of the target device 102, a proximity of the tire relative to a parking line of the structure 104, and/or the like. The component orientation may include a current orientation and/or a projected orientation of the moveable component 106. For example, the moveable component 106 may be configured to move along a movement path 410, and the projected orientation includes positions along the movement path 410. The movement path 410 may indicate whether the moveable component 106 has sufficient space to move with the target device 102 disposed in the position relative to the structure 104 (e.g., whether a door has sufficient room to open relative to the structure 104). In some implementations, the component orientation is determined using a component frame of reference 402 and the target device frame of reference 302 and/or the structure frame of reference 300. For example, the component frame of reference 402 may be compared with the target device frame of reference 302, which may then be compared together with the structure frame of reference 300. The component frame of reference 402 may be defined based on a component origin point 404. The component origin point 404 may be set at any location corresponding to the moveable component 106, including but not limited to, an attachment point, a movement point, a center, etc.

In some implementations, the component frame of reference 402 is fixed relative to the moveable component 106, and the target device frame of reference 302 is fixed relative to the target device 102. The target device frame of reference 302 and thus the target device 102 may be taken as stationary in determining the component relationship 400. In this example, the moveable component 106 and thus the component frame of reference 402 are configured to move relative to the target device frame of reference 302 and the target device 102. However, it will be appreciated that either frame of reference may be set as fixed or movable relative to the other in determining the component relationship 400. The component frame of reference 402 may include one or more component axes (e.g., a first component axis 406, a second component axis 408, etc.) extending from the component origin point 404. The component axes may be orthogonal to each other. In one example, the moveable component 106 is restricted to movement along lateral and longitudinal directions (e.g., within a component plane defined by the first and second component axes 406-408). The component frame of reference 402 may be compared with the target device frame of reference 302 (e.g., the first and/or second component axes 406-408 compared with the first and/or second target device axes 314-316) to determine the component relationship 400 between the moveable component 106 and the target device 102, which may inform the spatial relationship 110 of the position of the target device 102 and the structure 104 within the environment 100. A representation of the spatial relationship 110, which may include the component relationship 400, is generated for presentation using the presentation system 206, as described herein.

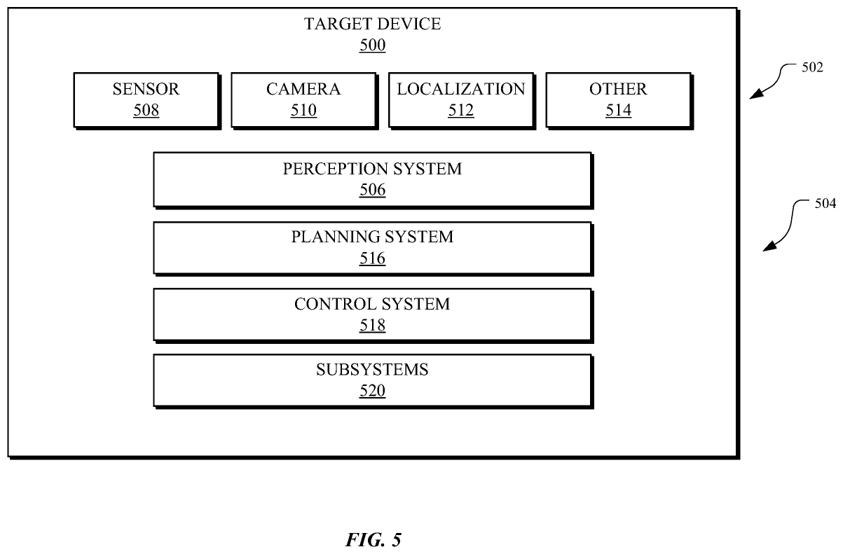

Turning to FIG. 5, an example target device 500, which may be the target device 102 and/or other target devices, is shown. In one implementation, the target device 500 includes one or more sensor systems 502 and device systems 504. It will be appreciated that any of a perception system 506, LIDAR sensors 508, cameras 510, localization systems 512, other sensors 514, a planning system 516, a control system 518, and/or subsystems 520 may be part of or separate from the device systems 506. The subsystems 520 may include one or more communication systems, including, without limitation, one or more antennae, receivers, transponders, transceivers, and/or communication ports. The subsystems 520 may include software, hardware, and/or structures corresponding to the moveable components 106, which may include a steering system, wheels, doors, trunks, hoods, windows, and/or the like.

The sensor system 502 includes one or more sensors configured to capture sensor data of a field of view of the target device 500, such as one or more images, localization data corresponding to a location, heading, and/or orientation of the target device 500, movement data corresponding to motion of the target device 500, and/or structure data corresponding to the structure 104. The one or more sensors may include, without limitation, 3D sensors configured to capture 3D images, 2D sensors configured to capture 2D images, RADAR sensors, infrared (IR) sensors, optical sensors, and/or visual detection and ranging (ViDAR) sensors. For example, the one or more 3D sensors may include the LIDAR sensors 508 (e.g., scanning LIDAR sensors) or other depth sensors, and the one or more 2D sensors may include the cameras 510 (e.g., RGB cameras). The cameras 510 may capture color images, grayscale images, and/or other 2D images. The localization systems 512 may capture the localization data. The localization systems may include, without limitation, GNSS, inertial navigation system (INS), inertial measurement unit (IMU), global positioning system (GPS), altitude and heading reference system (AHRS), compass, and/or accelerometer. The other sensors 514 may be used to capture sensor data, localization data, movement data, access identification data, and/or other authorized and relevant data.

The perception system 504 can generate perception data, which may detect, identify, classify, and/or determine position(s) of one or more objects using the sensor data. The perception data may be used by a planning system 516 in generating one or more actions for the target device 500, such as generating a motion plan having at least one movement action for autonomously moving the target device 500 along a movement path from an origin towards a destination, including into the position. A control system 518 may be used to control various operations of the target device 500 in executing the motion plan. The motion plan may include various operational instructions for subsystems 520 of the target device 500 to autonomously execute to perform the navigation action(s), as well as other action(s), such that the target device 500 moves on its own planning and decisions. Instructions for operating the target device 500 in view of a movement path may be executed by the planning system 516, the control system 518, the subsystems 520, and/or other components of the target device 500. The instructions may be modified prior to execution by the target device 500, and in some cases, the target device 500 may disregard the instructions, for example, based on the sensor data captured by the sensor system 502. The sensor systems 502 and/or the device systems 504 may be used to identify the structure 104 and determine the spatial relationship 110. The device systems 504 may further generate and execute a motion plan based on a movement command specifying an action for movement by the target device 500 based on the representation of the spatial relationship 110.

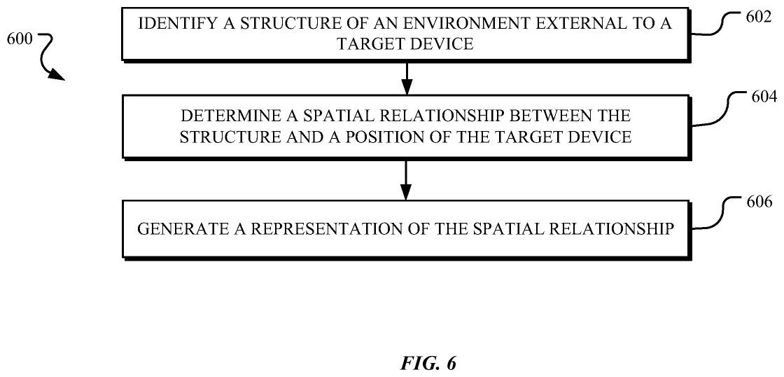

Turning to FIG. 6, example operations 600 for device positioning are illustrated. In some implementations, an operation 602 identifies a structure of an environment external to a target device. The target device is disposed in a position within the environment. The target device may be caused to move into the position in response to a storage command or otherwise in connection with execution of a storage operation. The operation 602 may use sensor data captured by at least one sensor of the target device to identify the structure.

An operation 604 determines a spatial relationship between the structure and the position of the target device within the environment. The spatial relationship may include an orientation of the target device relative to the structure. The orientation may include, without limitation, heading, tilt, proximity, and/or the like. In some examples, the target device includes a moveable component. The spatial relationship may thus include a component relationship between the structure and the moveable component. The component relationship may include a component orientation relative to the target device, a component movement path, and/or the like.

In some implementations, the operation 602 defines a structure frame of reference having a structure axis extending from a structure origin point, and the operation 604 determines the orientation of the target device relative to the structure based on a comparison of the structure frame of reference to a target device frame of reference. The target device frame of reference may have a target device axis, and the target device frame of reference may be defined by a target device origin point of the target device. The target device may be configured to move along a movement path, with the movement path corresponding to the target device axis. In this example, the orientation of the target device relative to the structure includes a heading of the target device relative to the structure, with the heading determined based on an angle of the target device axis relative to the structure axis. Similarly, the orientation of the target device relative to the structure may include a tilt of the target device relative to the structure, with the tilt determined based on an angle of a second target device axis relative to the structure axis. The second target device axis may extend orthogonally to the target device axis. The orientation of the target device relative to the structure may include a proximity of the target device relative to the structure, with the proximity determined based on a separation of the target device origin relative to the structure origin. The proximity may be further determined based on a known distance between the target device origin and one or more points on the target device. In examples where the target device includes a moveable component mounted at a component origin and the moveable component is configured to move relative to the target device axis, the orientation of the target device relative to the structure may include an angle of a component axis relative to the target device axis. The component axis extends from the component origin in this example.

An operation 606 generates a representation of the spatial relationship between the structure and the position of the target device. The representation of the spatial relationship may be output for presentation using a user device, a display, and/or a presentation system. The representation of the spatial relationship may include an outer shape of the target device and at least one surface shape of the structure. In some examples, the representation of the spatial relationship is output for presentation in response to a query for the position of the target device from the user device. Further, a movement command may be received from the user device to adjust the position of the target device, and the position of the target device may be adjusted based on the movement command. Generally, a movement command may be received specifying an action for movement by the target device based on the representation of the spatial relationship. The action for movement by the target device, for example, may include moving the movable component from a first orientation to a second orientation, moving the target device from a first orientation to a second orientation, and/or other actions. In some implementations, a motion plan for adjusting the position of the target device is generated, for example in response to the movement command. The motion plan may be generated based on one or more objects present in the environment (e.g., the structure), the movement command, sensor data, and/or other information about the target device and/or the environment.

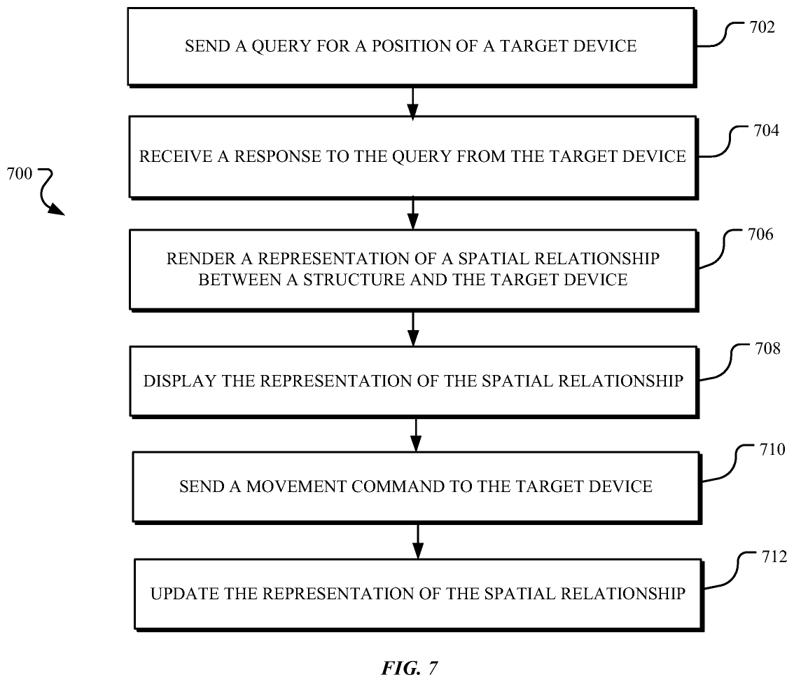

Turning to FIG. 7, example operations 700 for device positioning are illustrated. In some implementations, an operation 702 sends a query for a position of a target device, and an operation 704 receives a response to the query from the target device. Based on the response, an operation 706 renders a representation of a spatial relationship between the structure and the position of the target device within the environment. The spatial relationship may include an orientation of the target device relative to the structure. The orientation may include, without limitation, heading, tilt, proximity, and/or the like. In some examples, the target device includes a moveable component. The spatial relationship may thus include a component relationship between the structure and the moveable component. The component relationship may include a component orientation relative to the target device, a component movement path, and/or the like. An operation 708 displays the representation of the spatial relationship. In some examples the representation is displayed for interaction with a user. An operation 710 may receive input or automatically identify an orientation adjustment based on the representation of the spatial relationship and generate and send a movement command to the target device. The movement command may specify an action for movement by the target device. An operation 712 may update the representation of the spatial relationship based on execution of the action.

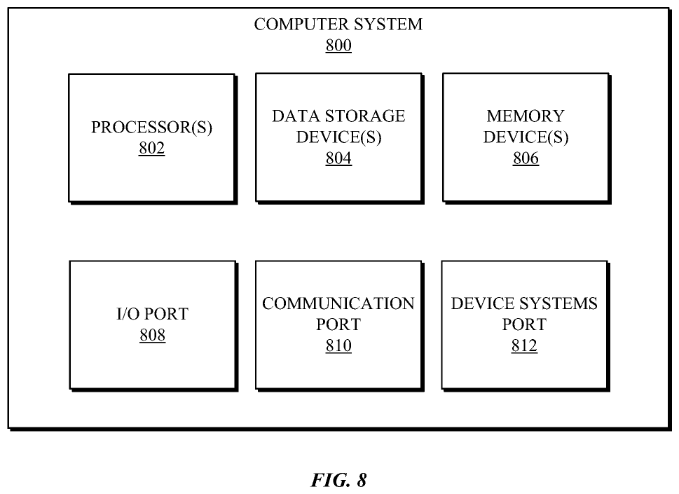

Referring to FIG. 8, a detailed description of an example computing device 800 having one or more computing units that may implement various systems and methods discussed herein is provided. Various components of the computing device 800 can be formed into a specific, non-conventional, and non-generic arrangement to achieve the various technological solutions discussed herein. As such, the computing device 800 and/or components of the computing device 800 may be applicable to the target device 102, the user device 108, various systems and subsystems of the target device 500, and other computing or network devices. In some examples, the target device 102 is a vehicle, but it will be appreciated that these devices may be various types of devices, such as robots, home electronic devices, interactive devices, drones, pods, security devices, user devices, and/or so forth. It will be appreciated that specific implementations of these devices may be of differing possible specific computing architectures not all of which are specifically discussed herein but will be understood by those of ordinary skill in the art.

The computing device 800 may be a computing system capable of executing a computer program product to execute a computer process. Data and program files may be input to the computing device 800, which reads the files and executes the programs therein. Some of the elements of the computing device 800 are shown in FIG. 8, including one or more hardware processor(s) 802, one or more data storage device(s) 804, one or more memory device(s) 806, and/or one or more port(s) 808-812. Additionally, other elements that will be recognized by those skilled in the art may be included in the computing device 800 but are not explicitly depicted in FIG. 8 or discussed further herein. Various elements of the computing device 800 may communicate with one another by way of one or more communication buses, point-to-point communication paths, or other communication means not explicitly depicted in FIG. 8.

The processor 802 may include, for example, a central processing unit (CPU), a microprocessor, a microcontroller, a digital signal processor (DSP), and/or one or more internal levels of cache. There may be one or more processors 802, such that the processor 802 comprises a single central-processing unit, or a plurality of processing units capable of executing instructions and performing operations in parallel with each other, commonly referred to as a parallel processing environment.

The computing device 800 may be a conventional computer, a distributed computer, or any other type of computer, such as one or more external computers made available via a cloud computing architecture. The presently described technology is optionally implemented in software stored on the data stored device(s) 804, stored on the memory device(s) 806, and/or communicated via one or more of the ports 808-812, thereby transforming the computing device 800 in FIG. 8 to a special purpose machine for implementing the operations described herein. Examples of the computing device 800 include personal computers, servers, purpose-built autonomy processors, terminals, workstations, mobile phones, tablets, laptops, wearables, so forth.

The one or more data storage devices 804 may include any non-volatile data storage device capable of storing data generated or employed within the computing device 800, such as computer executable instructions for performing a computer process, which may include instructions of both application programs and an operating system (OS) that manages the various components of the computing device 800. The data storage devices 804 may include, without limitation, magnetic disk drives, optical disk drives, solid state drives (SSDs), flash drives, so forth. The data storage devices 804 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and so forth. Examples of non-removable data storage media include internal magnetic hard disks, SSDs, and so forth. The one or more memory devices 806 may include volatile memory (e.g., dynamic random-access memory (DRAM), static random-access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 804 and/or the memory devices 806, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computing device 800 includes one or more port(s), such as an input/output (I/O) port(s) 808, communication port(s) 810, and sub-systems port(s) 812, for communicating with other computing, network, or vehicle devices. It will be appreciated that the ports 808-812 may be combined or separate and that more or fewer ports may be included in the computing device 800.

The I/O port 808 may be connected to an I/O device, or other device, by which information is input to or output from the computing device 800. Such I/O devices may include, without limitation, one or more input devices, output devices, and/or environment transducer devices.

In one implementation, the input devices convert a human-generated signal, such as, human voice, physical movement, physical touch or pressure, so forth, into electrical signals as input data into the computing device 800 via the I/O port 808. Similarly, the output devices may convert electrical signals received from computing device 800 via the I/O port 808 into signals that may be sensed as output by a human, such as sound, light, and/or touch. The input device may be an alphanumeric input device, including alphanumeric and other keys for communicating information and/or command selections to the processor 802 via the I/O port 808. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, so forth. In some implementations, the input device and the output device may be the same device, for example, in the case of a touchscreen.

The environment transducer devices convert one form of energy or signal into another for input into or output from the computing device 800 via the I/O port 808. For example, an electrical signal generated within the computing device 800 may be converted to another type of signal, and/or vice-versa. In one implementation, the environment transducer devices sense characteristics or aspects of an environment local to or remote from the computing device 800. Further, the environment transducer devices may generate signals to impose some effect on the environment either local to or remote from the example computing device 800.

In one implementation, a communication port 810 is connected to a network by way of which the computing device 800 may receive network data useful in executing the methods and systems set out herein as well as transmitting information and network configuration changes determined thereby. Stated differently, the communication port 810 connects the computing device 800 to one or more communication interface devices configured to transmit and/or receive information between the computing device 800 and other devices by way of one or more wired or wireless communication networks or connections. Examples of such networks or connections include, without limitation, Universal Serial Bus (USB), Ethernet, Wi-Fi, Bluetooth, Near Field Communication (NFC), cellular, and so on. One or more such communication interface devices may be utilized via the communication port 810 to communicate one or more other machines, cither directly over a point-to-point communication path, over a wide area network (WAN) (e.g., the Internet), over a local area network (LAN), over a cellular (e.g., third generation (3G), fourth generation (4G) network, or fifth generation (5G)), network, or over another communication means. Further, the communication port 810 may communicate with an antenna for electromagnetic signal transmission and/or reception. In some examples, an antenna may be employed to receive Global Positioning System (GPS) data to facilitate determination of a location of a device.

The target devices discussed herein may include a vehicle. The computing device 800 may include a sub-systems port 812 for communicating with one or more systems to control an operation of the vehicle and/or exchange information between the computing device 800 and one or more sub-systems of the vehicle. Examples of such sub-systems, include, without limitation, imaging systems, radar, LIDAR, motor controllers and systems, battery control, fuel cell or other energy storage systems or controls in the case of such vehicles with hybrid or electric motor systems, processors and controllers, steering systems, brake systems, light systems, navigation systems, environment controls, entertainment systems, and so forth.

The present disclosure recognizes that participation in device positioning may be used to the benefit of users. Entities implementing the present technologies should comply with established privacy policies and/or practices that meet or exceed industry or governmental requirements for maintaining the privacy and security of data being communicated. Moreover, users should be allowed to opt-in or opt-out of allowing a target device to participate in such services. Third parties can evaluate these implementers to certify their adherence to established privacy policies and practices.

The system set forth in FIG. 8 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order and are not necessarily meant to be limited to the specific order or hierarchy presented. The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer).

While the present disclosure has been described with reference to various implementations, it will be understood that these implementations are illustrative and that the scope of the present disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. One or more tangible non-transitory computer-readable storage media storing computer-executable instructions for performing a computer process on a computing system, the computer process comprising:
identifying a structure of an environment external to a target device, the target device disposed in a position within the environment;
determining a spatial relationship between the structure and the position of the target device within the environment, the spatial relationship including an orientation of the target device relative to the structure; and
generating a representation of the spatial relationship between the structure and the position of the target device, the representation of the spatial relationship output for presentation using a user device.

2. The one or more tangible non-transitory computer-readable storage media of claim 1, wherein the representation of the spatial relationship is output for presentation in response to a query for the position of the target device from the user device.

3. The one or more tangible non-transitory computer-readable storage media of claim 1, wherein the representation of the spatial relationship includes an outer shape of the target device and at least one surface shape of the structure.

4. The one or more tangible non-transitory computer-readable storage media of claim 1, wherein the orientation includes at least one of heading, tilt, or proximity.

5. The one or more tangible non-transitory computer-readable storage media of claim 1, wherein the target device includes a moveable component, the spatial relationship including a component relationship between the structure and the moveable component, the component relationship including a component orientation relative to the target device.

6. The one or more tangible non-transitory computer-readable storage media of claim 1, further comprising:
receiving a movement command from the user device to adjust the position of the target device; and
causing the target device to adjust the position of the target device based on the movement command.

7. The one or more tangible non-transitory computer-readable storage media of claim 6, wherein causing the target device to adjust the position of the target device comprises:
generating a motion plan for adjusting the position of the target device, the motion plan being generated based on one or more objects present in the environment and the movement command, the one or more objects including the structure.

8. The one or more tangible non-transitory computer-readable storage media of claim 1, further comprising:
causing the target device to move into the position in response to a storage command.

9. A method comprising:
obtaining sensor data, the sensor data captured using at least one sensor of a target device;
identifying a structure of an environment external to the target device using the sensor data, the target device disposed in a position within the environment;
determining a spatial relationship between the structure and the position of the target device within the environment, the spatial relationship including an orientation of the target device relative to the structure; and
generating a representation of the spatial relationship between the structure and the position of the target device, the representation output for display using a display associated with the target device.

10. The method of claim 9, wherein identifying the structure includes defining a structure frame of reference having a structure axis extending from a structure origin point, the orientation of the target device relative to the structure determined based on a comparison of the structure frame of reference to a target device frame of reference having a target device axis, the target device frame of reference defined by a target device origin point of the target device.

11. The method of claim 10, wherein the target device is configured to move along a movement path, the movement path corresponding to the target device axis.

12. The method of claim 11, wherein the orientation of the target device relative to the structure includes a heading of the target device relative to the structure, the heading determined based on an angle of the target device axis relative to the structure axis.

13. The method of claim 11, wherein the orientation of the target device relative to the structure includes a tilt of the target device relative to the structure, the tilt determined based on an angle of a second target device axis relative to the structure axis, the second target device axis extending orthogonally to the target device axis.

14. The method of claim 10, wherein the orientation of the target device relative to the structure includes a proximity of the target device relative to the structure, the proximity determined based on a separation of the target device origin relative to the structure origin.

15. The method of claim 14, wherein the proximity is further determined based on a known distance between the target device origin and one or more points on the target device.

16. The method of claim 11, wherein the target device includes a moveable component mounted at a component origin, the moveable component configured to move relative to the target device axis, the orientation of the target device relative to the structure including an angle of a component axis relative to the target device axis, the component axis extending from the component origin.

17. A system comprising:
a controller rendering a representation of a spatial relationship between a structure of an environment external to a target device and a position of the target device within the environment, the spatial relationship including an orientation of the target device relative to the structure; and
a display displaying the spatial relationship between the structure of the environment external to the target device and the position of the target device within the environment.

18. The system of claim 17, further comprising:
an input system receiving a movement command, the movement command specifying an action for movement by the target device based on the representation of the spatial relationship.

19. The system of claim 18, wherein the target device includes a movable component, the action for movement by the target device including moving the movable component from a first orientation to a second orientation.

20. The system of claim 17, wherein the target device includes a movable component, the spatial relationship including a component relationship between the structure and the moveable component, the component relationship including a component movement path.
